(19) United States
(12) Patent Application Publication
(10) Pub. No.: US 2014/0012930 A1
(43) Pub. Date: Jan. 9, 2014

(54) SHARING EMOTION USING REMOTE CONTROL COMMANDS

(71) Applicant: Life of Two, San Francisco, CA (US)

(72) Inventors: Bianca Weishaupl, San Francisco, CA (US); Roman Weishaupl, San Francisco, CA (US); Tyson Verstraete, San Francisco, CA (US)

(73) Assignee: Life of Two, San Francisco, CA (US)

(21) Appl. No.: 13/919,672

(22) Filed: Jun. 17, 2013

Related U.S. Application Data
(60) Provisional application No. 61/660,644, filed on Jun. 15, 2012.

(51) Int. Cl. H04L 12/58

(52) U.S. Cl. CPC H04L 51/18
USPC 709/206

(57) ABSTRACT

Sending emotional feelings through remote control commands and allowing one person to control another person's co-operating application. Sending emotional commands between people having an established relationship and who are in the midst of an conversation and causing actions to change the remote computer thus creating an emotional in the recipient.

### CROSS REFERENCE TO RELATED APPLICATIONS

This application is a claims priority to U.S. Application No. 61/660,644, entitled “SYSTEM AND METHOD FOR SHARING AN EMOTION THROUGH THE USE OF REMOTE CONTROL COMMANDS”, filed Jun. 15, 2012, of which the full disclosure of this application is incorporated herein by reference for all purposes.

### BACKGROUND

1. Technical Field

The present disclosure relates to the transmission of messages and more specifically to transmitting emotional feelings using remote control commands.

2. Introduction

Text messaging, instant messaging, micro blogging, social networking, etc. has become common place in most of the world and is used by many people when interacting via computers. The concept of sending small icons in messages to represent emotions (“emoticons”) is also commonly done. Emoticons are just one example of how people are taking a common form of communication and adapting it to mirror how their face-to-face interactions take place. Naturally people also share feelings with words, but sometimes more subtle forms of communication say more than the overt forms.

Recently there have been advances in point-to-point interaction that assist when sharing emotions. In 2011, interaction designer and graduate of the Copenhagen Institute of Design Marco Triverio publicly outlined on the internet an innovative interaction style for two people using mobile phones. When both are looking at their mobile phones in a conversation they are having, touches on the screen of one side are shown on the other side as small dots. Touching the same spot triggers a small reaction, such as a vibration or a sound, acknowledging that both parts are there at the same time (http://www.cs.uic.edu/˜mtriveri/Marco_Triverio/Marco_Triverio.html).

Real-time online interaction is common in gaming circles and used when playing games like chess, checkers and many other board games. Now companies are taking this old technology and allowing people to share their emotion and expression through their computers. There are also drawing applications that allows two people to draw together. However, these types of synchronous communication methods can be very problematic when dealing with mobile communications. The ability to have two unknown applications share such real-time interactions is also difficult. Additionally the types of emotions you can share when doing synchronous communications is also limited and negative emotions are difficult to share in such a specific synchronous manner. This is because both the sender and receiver have to in the exact same frame of mind and in agreement with what is about to happen. If I am frustrated and angry and the other person knows that they are not going to want to interact with me real-time to receive my angry feeling in a synchronous fashion.

Taking the two fingers touching concept further are remote control products like VNC (Virtual Network Computing). VNC allows one person to completely take control of another person's computer. This type of application is commonly used in IT technical support services. Although this could be used to interact between two peoples, the VNC product has never been used in that way. It is also possible to receive PING messages within your application, but these are similar to receiving a message with a vibration notification set on your smartphone. In other examples it is also possible to receive messages on your smartphone that update visual icon's to indicate you have received a message. However, none of these notifications are emotionally based and do not share a feeling between two people.

The potential for sharing emotion can expand how we use social networks and data communications. There is still a need to allow people deeper and more meaningful conversations when working through computer communication channels. Solving the problems of dealing with negative feelings and asynchronous method for sharing emotion is still required.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for sending messages that cause changes to a recipient's computer environment. Some embodiments of the present technology involve systems and methods for sending emotional feelings through remote control commands. The remote control command can be utilized in a wide range software applications and can allow one person to control another person's co-operating application. In some embodiments, the commands can be sent between people that have an established social relationship and who are in the midst of an actual conversation and can result in noticeable changes to the remote computer thus creating an emotional effect of some kind or another.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system where an exchange of credentials can take place for social networking purposes according to some embodiments of the present technology.

FIG. 2 illustrates an exemplary interface for expressing feelings through remote commands according to some embodiments of the present technology.

FIG. 3 illustrates an exemplary interface after receiving a command instruction from a sender that causes an action that can impart emotion according to some embodiments of the present technology.

FIG. 4 illustrates an exemplary interface after receiving a command instruction from a sender that causes an action that can impart emotion according to some embodiments of the present technology.

FIG. 5 illustrates a method of sending a command instruction along with a message according to some embodiments of the present technology.

FIG. 6A and FIG. 6B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

A system, method and non-transitory computer-readable media are disclosed which allow users to send emotional feelings through remote control commands.

To address these concerns and challenges presented an advanced method for sending emotional feelings through remote control commands is described. The remote control command adds to co-operating data communication software applications to allow one person to control another person's co-operating application. Some embodiments of the present technology, can provide the ability to send an emotion asynchronously through a remote control command between co-operating applications results in a direct effect on the corresponding remote computer system. Such commands can be sent between people that have an established social relationship and who are in the midst of an actual conversation.

In some embodiments, the remote command results in a concrete change to the remote computer thus creating an emotional effect of some kind or another. Naturally each person is different and the quality of the implementation can change the type and quality of emotional response.

Since the communication is send asynchronously it can be received over a wide variety of medium that are commonly used today. This also leads toward a standardization of command structures so that independent applications can have the commands built-in and can interpreter them for their user base. The user of an asynchronous command also means that it is very easy to send a wide variety of positive and negative feelings, mirroring much more closely each person's real-life experience together. As long as two people have a relationship one person is capable of sending angry, frustrated or mad feelings to the other person and they are simply left with accepting those feelings.

The term emotional command implies a physical action one user takes with the intention of sending an emotion to another person. This is not just receiving a message and your phone vibrates. The intention is closely associated to the context in which the two users find themselves when the message is sent and received. When two people are in the midst of a conversation it opens the door for sharing feelings and emotions. For example in an exchange of messages where a disagreement is building the sending of an angry remote control command has the impact of sharing the anger you are feeling. This is where the intention comes from, i.e. the context being shared between two people over a given period of time.

The term co-operating data communication software applications (co-operating applications) is meant to refer to any two pieces of software on physically different computer systems that share proprietary commands that can be exchanged in a near real-time fashion. Some examples of near real-time applications would be SMS texting, instant messaging, email, social media messaging, video chatting, and other point-to-point communication methods. Co-operating applications can also refer to private solutions like LivePerson, BoldChat, LifeofTwo and many other social media related applications. Naturally both applications do not have to be identical. As long as the two applications understand the same remote control commands then any application could be used on each end of the conversation.

The term computer systems refers ideally to handheld computer systems like Cellphones, Smartphones, Tablets computers, Personal Digital Assistants (PDAs), Netbooks and Chromebooks. The term computer system is not limited to handheld devices however and desktop or laptop computers are also applicable in similar ways. Both desk-based computers and handheld computers can also be further enhanced with specially attached peripherals, mouse inputs, USB connected equipment and yet-to-be-invented emotional attachment equipment which could be attached at any time. Therefore in this application the term computer system is meant to include any and all attached peripherals that can be controlled by the computer system to perform actions on the computer's behalf. Peripherals could also included Bluetooth™ attached devices that might fit into the ear or into a pocket of computer user.

The term emotional effect is used to denote a connection between a change in the computer and the effect it can have on the emotions of a person. If you are having a disagreement and your computer temporarily stops functioning you might feel frustrated, angry, sad or disappointed. If you are sharing some good news and the characters you were typing and receiving suddenly changed from the font Arial to a wide fancy script you might feel cared about, loved, special or understood. If you are sharing some sad feelings via a message exchange and a command is received by a desktop computer that sends a warm hug it might cause a specially modified mouse to warm up slightly for the user. Such a warm hug command could also be received by a Smartphone with a Bluetooth attached pocket peripheral that warms slightly when the Smartphone commands it. Such a warming effect might result in supportive feelings, a feeling of being cared about and a deep expression of love. These effects and many others are intended when using the term emotional effect.

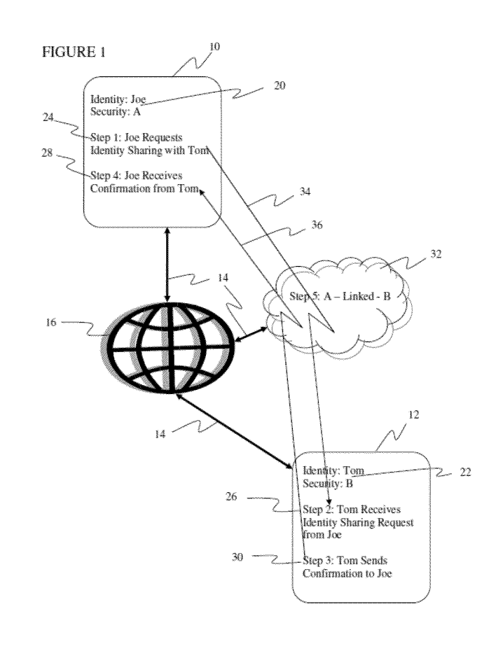

FIG. 1 illustrates an exemplary system where an exchange of credentials can take place for social networking purposes according to some embodiments of the present technology. For illustration purposes there are two individual systems shown 10, 12. The first system 10 is represented by an identity of Joe 20 with a security value of ‘A’ 20. Joe could be a pseudonym, a nickname, a Facebook™ reference or the person's actual first name. The security value could be a password, a reference number assigned by the social networking system or some unique identify used to ensure that every other Joe is not confused with this Joe. The second system 12 has an identity of Tom 22 with a security value of ‘B’. These two systems are running a common social networking application that connects through a common connection method 14 to a wide area global network 16. The connection could be a wireless link, a land-line link a modem or some other form of physical data communication means. The global network 16 could be the Internet, private company-wide network, etc.

FIG. 1 also illustrates data flow involved in sharing one person's identity with another person. After creating an account in a social network, one party in this case Joe 20 requests identity sharing with Tom 24. This logical request 34 is sent through the global network 16 to an identity sharing cloud 32 used by many social network providers. The cloud 32 both protects the real identity of each subscriber while allowing them to search the full set of subscribers for those they know. As the request 34 passes through the cloud the service makes note of a half-open connection between Joe and Tom. This request is then routed to Tom via the global network to his computer 12. Next, Tom receives the request 26 and decides what to do with it. Eventually Tom either accepts or rejects the request and in this example step three is Tom sending a confirmation back to Joe 30. This logical acceptance 36 passes through the global network back through the cloud and is routed back to Joe computer 10. Next, Joe receives the confirmation from Tom 28 which changes the state within his program to indicate he is fully connected to Tom. Additionally, the network service cloud 32 also makes note of the fact that Joe and Tom now have a fully formed linkage. This linkage will perform a wide range of services within the social network cloud 32 depending on what each social network offering has implemented and offered to their customers.

It would be well understood by anyone skilled in the art of data communications and social networks that other embodiments are easily implemented. For example it would be entire possible to remove the social network cloud 32 and have the identity exchange requests pass directly between the two parties 10, 12. This might reduce the identity protection but in many cases this protection is not required, especially among family members or close friends.

In some embodiments of the present technology, a messaging application module on a senders device causes command instructions to be sent along messages and a messaging application module on the recipients device causes an action on the recipients device.

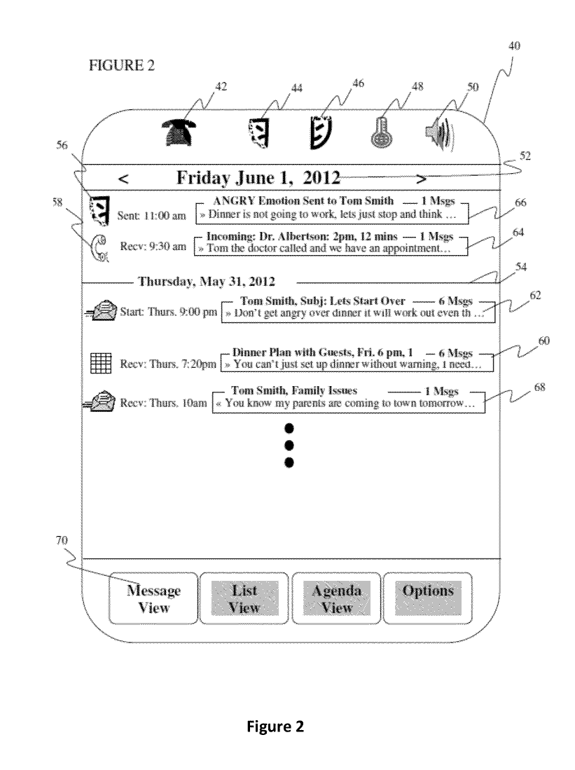

FIG. 2 illustrates an exemplary interface for expressing feelings through remote commands according to some embodiments of the present technology. As shown in FIG. 2, an interface displays a first half of a conversation 40 between two social network correspondents. The screen presented 40 is one exemplary embodiment where icons represent buttons on a touch-screen computer. The screen can be viewed in a number of ways including advanced message view 70, List View, Agenda View, etc. In message view, a series of icons 42, 44, 46, 48, 50 represent different emotional commands to be sent that through the program.

In some embodiments, a user can configure any number of icons and their meanings during their configuration stage. In this embodiment the icons shown will cause a variety of effects on the receiving computer when two users are in the midst of a conversation. The phone icon 42 might send a message along with a command instruction that can automatically the recipient's phone application.

In some embodiments of the present technology, the command instruction comprises a non-recurring state override command that instructs the co-operating application to change state in a device's operation. For example, the non-recurring state override command can cause a receiving device's screen brightness to change, can cause the suspension of the receiving device's services (e.g. suspend message sending ability to one or more contacts), cause the receiving device to launch an application (e.g. a phone dialing application), cause the receiving device to send an instruction to a connected peripheral device, etc. Although, these examples of changes to device operations are included explicitly, those with ordinary skill in the art having the benefit of this disclosure will readily appreciate that a wide variety of changes in operation can be affected by command instructions.

In an illustrative example, the message might be “hey, its time you gave me a call soon!”. The sad face icon 44 might represent sadness or anger and be sent when problems are encountered. The sad face icon 44 can be used to send a command instruction that causes the message application to stop, grey out the screen, place a sad face over the screen, or many other such side effects. The happy face icon 46 might be used to send command instructions that impart happy feelings, gladness or good tidings. For example, a happy face can send a command instruction that causes the recipient's screen to get brighter, place a sun face on the screen or change the font used in the conversation to a fun and happier font for some amount of messages. The temperature icon 48 can be sent to send hot feelings or sexual feelings to the recipient. For example, the temperature icon can cause the transmission of a command instruction that causes a recipient's attached peripherals to get warmer, like a Bluetooth attached pocket warmer or other adult device. The music icon 50 can be sent with a command instruction that causes the recipient's device to play a sound or ringtone on the receiver's computer. Depending on the ringtone a wide-range of emotions could be expressed through the sounds heard during a conversation.

In some embodiments, the messaging application module can also separates daily event with a date title separator 52, 54 and between each date separator are a series of events that have taken place 60, 62, 64, 66, 68. Each event that has taken place is also identified by an icon 56, 58 to assist the user in quick identification of what has taken place in their social network circle. This circle could be several hundred people or just two people like a husband and wife.

In this example is highlighted by exchange 68 where Tom receives a message within a conversation around a Family Issue 68. This is followed by the reception of a calendar event at 7:20 pm that books Tom's time on Friday at 6 pm 60. This causes a new exchange of emails starting at 9:00 pm where Tom gets angry over dinner planned without his input 62. The emails go quiet until Friday when an incoming call 58 is received at 9:30 on Friday 64. This causes another conversation to open 64 and reminds Tom he is still angry over dinner plans. Tom then decides to send an angry emotion 56 at 11:00 am to the other person, Joe for the sake of this example 66. We then turn to FIG. 2 to see the result of sending the angry emotion.

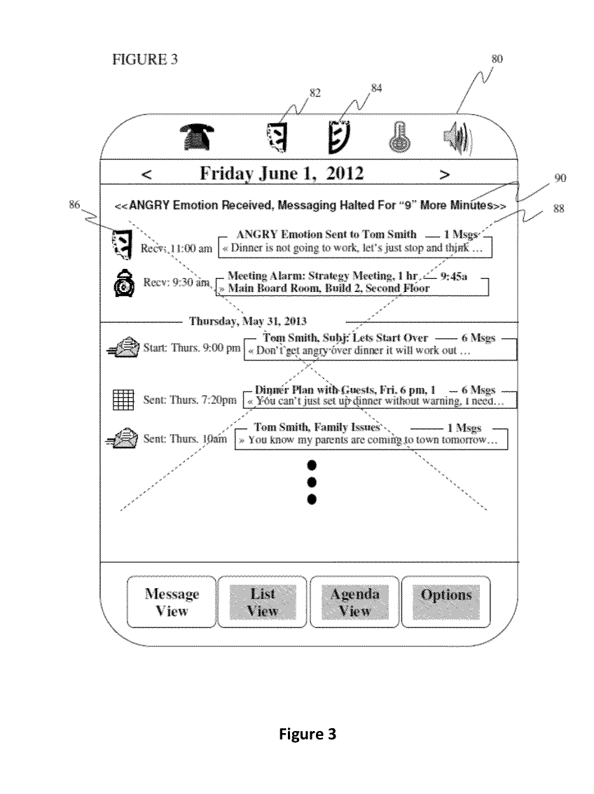

FIG. 3 illustrates an exemplary interface after receiving a command instruction from a sender that causes an action that can impart emotion according to some embodiments of the present technology. As shown in FIG. 3, the second half 80 of the conversation occurs between two social network correspondents. In this half of the screen conversation 80 the angry emotion 86 is received at 11:00 am and several things can happen to Joe's screen 80. The first is a dotted ‘X’ has appeared 88 indicating that communication is blocked with Tom for a predetermined amount of time. Secondly a message appears at the top of the screen indicating that “Messages are Halted for “9” more minutes” to indicated that messaging with Tom has been suspended. In one exemplary embodiment this could be a changing count-down message showing the minutes and seconds remaining before the messaging application becomes unblocked.

This type of suspension of the messaging application has no lasting effect only a temporary feeling of being annoyed. With the sharing of emotion in real life this method sharing emotion between co-operating applications allows one person to impart part of what they are feeling themselves. Naturally the person that has their screen blocked also gets angry at first, but then compassion for the other person sets in and they realize how helpless or desperate the sender was when they sent it.

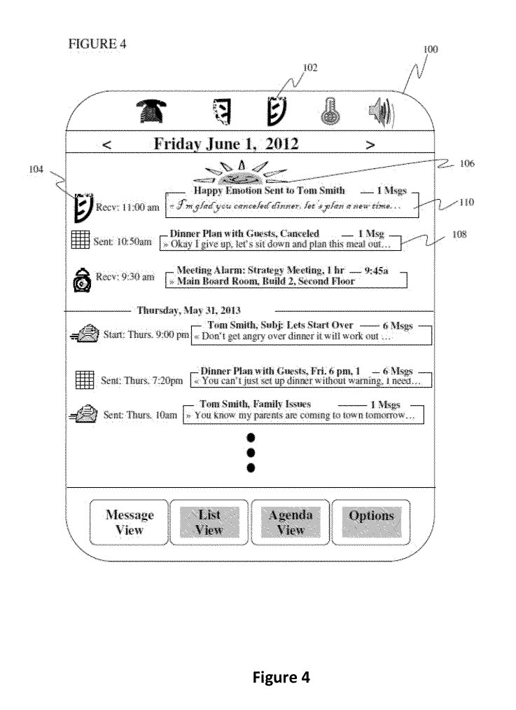

FIG. 4 illustrates an exemplary interface after receiving a command instruction from a sender that causes an action that can impart emotion according to some embodiments of the present technology. FIG. 4 show another embodiment of the second half of the conversation 100 between two social network correspondents. In this example Joe has sent a message at 10:50 indicating the dinner plans have been canceled 108. In response Tom sends a happy emotion 104 that places an icon on the screen 106 and changes the font of the message just sent by Tom to playful italics 110.

For one skilled in the art there could be many ways to indicate a happy emotion on the screen or on the device. For example the device could have vibrated a few times to give the person a jolt. The screen could have shown some tears of happiness flowing down from the top. The other examples at the top represent other possible emotions as described earlier.

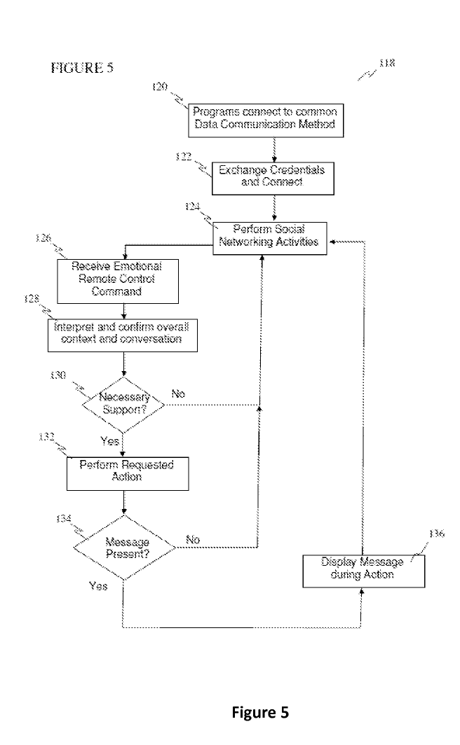

FIG. 5 illustrates a method of sending a command instruction along with a message according to some embodiments of the present technology. FIG. 5 is a simplified data flow diagram 118 showing some of the steps used to exchange emotional using remote control commands. Each individual is using a software application that is compatible with the other. These might be the same programs or they could be different programs that understand a common data communication protocol. These programs each establish a common data communication method 120. This method 120 could be through a common cloud service or it could be a point-to-point communication method. With the individuals programs connected to a common data communication method 120 the two or more users can exchange credentials and connect to one another 122. During this period they perform normal social network activities 124. Such activities are commonly seen as exchanging messages, exchanging pictures, having video and audio conferences and a wide range of social tracking like GPS tracking and monitoring of each other.

Eventually one person sends, via their computer program, an emotional command asynchronously to the other person. There is no co-operation required to receive this command other than a relationship has been established. This command is received by one or more of the connected individual programs 126. The command is interpreted and a confirmation is performed 128 to ensure the command is understood and occurs within a known conversation. A check is performed to ensure the local program and computer system is capable of executing the command 130. The command could be coming from a newer application and is not yet understood by the older program. The command might request a peripheral to be turned on to create a warming effect. If such a peripheral is not attached then the program ignores the command and returns to perform other social networking activities 124. If the command is understood the requested action is performed on behalf of the sender 132. A check is then made to see if a message was also present with the action 134. If no message is present then the software returns to perform normal social network activities 124. If there is a message then the message is displayed during the action 136. Once the action is complete the software returns to perform normal social networking activities 124.

For one skilled in the art there could be additional verification steps used and additional steps added for the reminder construction, but these changes would not affect the overall action of the software.

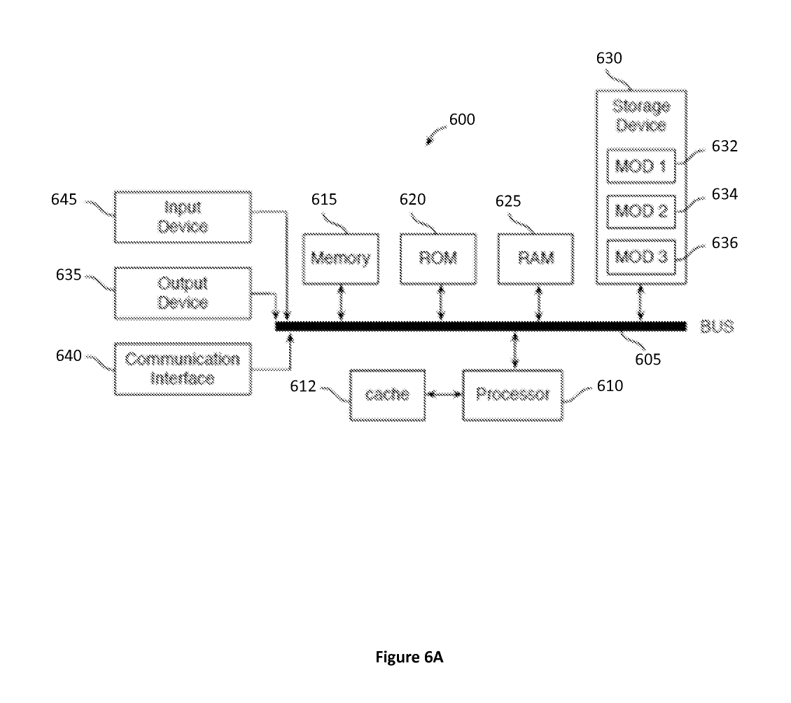

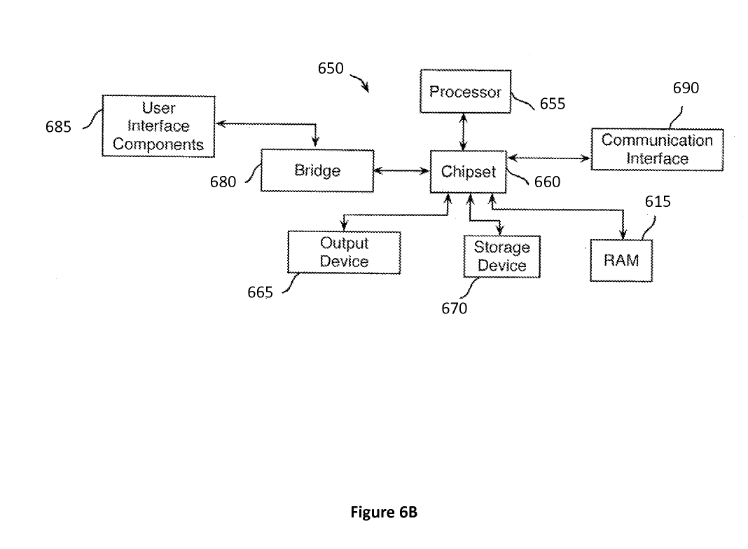

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles

We claim:

1. A computer-implemented method for sharing an emotion comprising:
receiving, in a messaging application on a user electronic device, an instruction to allow state override commands received from messages originating from a specified sender electronic device to perform an action to change the operation of the user electronic device;
receiving a message along with a non-recurring state override command from the sender electronic device;
selecting an action to perform based on the non-recurring state override command; and
performing the action.

2. The computer-implemented method of claim 1, wherein the non-recurring state override command is sent in response to a user of the sender electronic device selecting a command involving an emotion and wherein the action is designed to impart the emotion to a user of the user electronic device.

3. The computer-implemented method of claim 1, wherein the action suspends the ability of the user electronic device to send massages for a predetermined amount of time.

4. The computer-implemented method of claim 1, wherein the action changes the brightness of the user electronic device for a predetermined amount of time.

5. The computer-implemented method of claim 1, wherein the action causes a phone dialing application to launch and display a phone dialing interface on the user electronic device.

6. The computer-implemented method of claim 1, wherein the action causes a peripheral attachment to the user electronic device to perform an action.

7. An electronic device for sharing emotion comprising:
a processor;
a network interface; and
a messaging module configured to control the processor to:
receive an instruction to allow state override command received from messages originating from a specified sender electronic device to perform an action to change the operation of the electronic device;
receive a message, via the network interface, along with a non-recurring state override command from the sender electronic device;
select an action to perform based on the non-recurring state override command; and
perform the action.

8. The electronic device of claim 7, wherein the non-recurring state override command is sent in response to a user of the sender electronic device selecting a command involving an emotion and wherein the action is designed to impart the emotion to a user of the user electronic device.

9. The electronic device of claim 7, wherein the action suspends the ability of the user electronic device to send massages for a predetermined amount of time.

10. The electronic device of claim 7, wherein the action changes the brightness of the user electronic device for a predetermined amount of time.

11. The electronic device of claim 7, wherein the action causes a phone dialing application to launch and display a phone dialing interface on the user electronic device.

12. The electronic device of claim 7, wherein the action causes a peripheral attachment to the user electronic device to perform an action.

13. A non-transitory computer-readable storage medium comprising:
a medium configured to store computer-readable instructions thereon; and
the computer-readable instructions that, when executed by a processing device cause the processing device to perform a method, comprising:
receiving, in a messaging application on a user electronic device, an instruction to allow state override commands received from messages originating from a specified sender electronic device to perform an action to change in the operation of the user electronic device;
receiving a message along with a non-recurring state override command from the sender electronic device;
selecting an action to perform based on the non-recurring state override command; and
performing the action.

14. The non-transitory computer-readable storage medium of claim 13, wherein the non-recurring state override command is sent in response to a user of the sender electronic device selecting a command involving an emotion and wherein the action is designed to impart the emotion to a user of the user electronic device.

15. The non-transitory computer-readable storage medium of claim 13, wherein the action suspends the ability of the user electronic device to send massages for a predetermined amount of time.

16. The non-transitory computer-readable storage medium of claim 13, wherein the action changes the brightness of the user electronic device for a predetermined amount of time.

17. The non-transitory computer-readable storage medium of claim 13, wherein the action causes a phone dialing application to launch and display a phone dialing interface on the user electronic device.

18. The non-transitory computer-readable storage medium of claim 13, wherein the action causes a peripheral attachment to the user electronic device to perform an action.
